(19) United States
(12) Patent Application Publication
(10) Pub. No.: US 2026/0312679 A1
(43) Pub. Date: Oct. 8, 2026

(54) SIGNAL MONITORING USING LINEAR OPTICS

(71) Applicant: CISCO TECHNOLOGY, INC., San Jose, CA (US)

(72) Inventors: Ye WANG, San Jose, CA (US); Adee RAN, Maayan Baruch (IL); Eran NUSSBAUM, Herzliya (IL); Dror NOHI, Petah Tikva (IL); Fabio BOTTONI, Milano (IT); Alessandro CAVACIUTI, San Donato Milanese - Milano (IT)

(21) Appl. No.: 19/173,327

(22) Filed: Apr. 8, 2025

(51) Int. Cl. H04B 10/073

(52) U.S. Cl. CPC H04B 10/073

(57) ABSTRACT

In one embodiment, a sniffer device includes a first connector and a second connector, wherein the first connector and the second connector are each configured to receive electrical signals. The sniffer device further includes first and second electrical to optical converters and first and second optical to electrical converter connected between the first connector and the second connector. The sniffer device includes a signal tap between the first electrical to optical converter and the first optical to electrical converter and a signal tap between the second electrical to optical converter and the second optical to electrical converter. The sniffer device includes an optical or electrical output corresponding to the signal tap between the first electrical to optical converter and the first optical to electrical converter and an optical or electrical output corresponding to signal tap between the second electrical to optical converter and the second optical to electrical converter.

### FIELD

The present disclosure relates to signal transmission and, more particularly, to signal monitoring and analysis of communication links to observe signals using linear optics.

### BACKGROUND

The statements in this section merely provide background information related to the present disclosure and may not constitute prior art.

Signal analyzing devices, such as protocol analyzers, can include a hardware device connection to communication links that allows for monitoring or observing signals transmitted across the communication links. For example, these devices allow for capturing and analyzing signals (e.g., data signals) as the signals are communicated across the communication links.

### DRAWINGS

In order that the disclosure may be well understood, there will now be described various forms thereof, given by way of example, reference being made to the accompanying drawings, in which:

FIG. 1 is a block diagram illustrating an example system in which electrical signals are monitored in accordance with various embodiments;

FIG. 2 is a block diagram illustrating an example of a link connection arrangement in accordance with various embodiments;

FIG. 3 is a block diagram illustrating an example of a link connection arrangement implementing a sniffer device in accordance with various embodiments; and

FIG. 4 is a block diagram of a computing device in accordance with various embodiments.

### DESCRIPTION OF EXAMPLE EMBODIMENTS

The following description is merely exemplary in nature and is not intended to limit the present disclosure, application, or uses. It should be understood that throughout the drawings, corresponding reference numerals indicate like or corresponding parts and features. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

### Overview

As will be discussed in more detail herein, systems, methods, and computer program products are provided for testing and/or monitoring signals. In various embodiments, a sniffer device includes a first connector; a second connector, wherein the first connector and the second connector are each configured to receive electrical signals; a first electrical to optical converter and a first optical to electrical converter connected between the first connector and the second connector; a second electrical to optical converter and a second optical to electrical converter connected between the first connector and the second connector; a signal tap between the first electrical to optical converter and the first optical to electrical converter configured to tap optical signals converted from the electrical signals received at the first connector; a signal tap between the second electrical to optical converter and the second optical to electrical converter configured to tap optical signals converted from the electrical signals received at the second connector; and an optical output corresponding to the signal tap between the first electrical to optical converter and the first optical to electrical converter and an optical output corresponding to signal tap between the second electrical to optical converter and the second optical to electrical converter.

### Example Embodiments

Different tools and mechanisms are available that may be used for link troubleshooting, monitoring, and/or analysis. The physical connection of these devices to the communication links (e.g., electrical communication lines) often introduce unwanted interference or require direct electrical contact, which can affect signal quality. For example, the use of these tools and mechanisms can result in signal degradation that makes is difficult to obtain information needed for signal analysis (e.g., protocol analysis, such as link training protocol analysis). Accordingly, it is desirable to provide improved methods and systems for signal acquisition (e.g., signal tapping) to allow for signal analysis. Furthermore, other desirable features and characteristics of the present disclosure will become apparent from the subsequent detailed description and the appended claims, taken in conjunction with the accompanying drawings and the foregoing technical field and background.

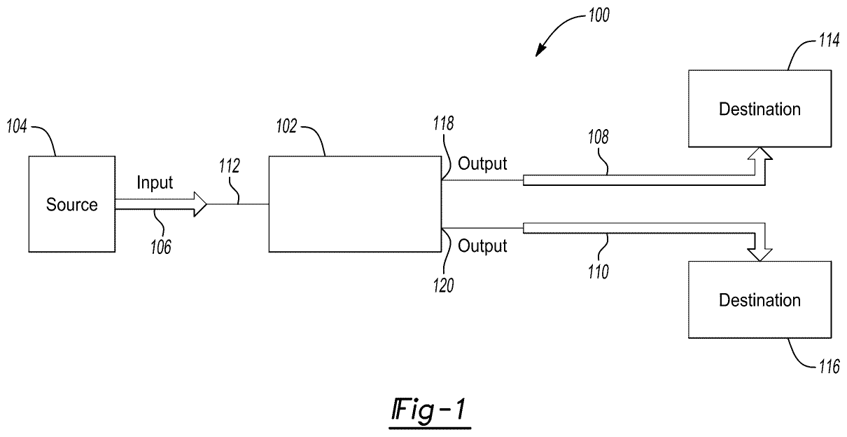

With reference to FIG. 1, a system 100 is shown that includes a sniffer device 102 in accordance with one or more embodiments. For example, the sniffer device 102 is configured in one or more examples as an Auto-Negotiation and Link Training (AN/LT) protocol analyzer or tester that can be used to test and debug the auto-negotiation and link training protocols for high-speed Ethernet, such as for 56-Gbps and 112-Gbps SerDes based Ethernet. However, it should be appreciated that the various embodiments may be implemented to sniff/tap any signal (at different signal rates) and the tapped-out signal can be fed to any test equipment. Additionally, the various embodiments may be implemented in different types of high-speed communication links, such as Ethernet, Peripheral Component Interconnect Express (PCIe), Universal Chiplet Interconnect Express (UCIe), Compute Express Link (CXL), NVLink, etc.

In high-speed Ethernet, Auto-Negotiation (AN) and Link Training (LT) are protocols that determine the communication parameters between two devices, such as speed, duplex mode, and FEC (Forward Error Correction), etc. Using one or more embodiments, correct and reliable operation of AN/LT is provided for high-speed Ethernet connections, including with the increased complexity of standards like 400GE and 800GE.

As can be seen in FIG. 1, the sniffer device 102 is configured to tap into a signal from a source 104 to perform signal sniffer operations. The sniffer device 102 receives an input signal 106 from the source 104 and outputs two output signals 108 and 110. In one or more embodiments, the sniffer device 102 can be attached to a copper cable assembly 112, such that the combined cable and device looks like a cable but has “sniffing” outputs (providing the two output signals 108, 110) using optical splitting as described in more detail herein. It should be appreciated that the sniffer device 102 can also be used to tap signals from multiple sources in a bi-directional arrangement as described in more detail herein.

The sniffer device 102 converts the received input signals 106, which are electrical signals, to one or more outputs, such as the two output signals 108, 110, which are optical or electrical signals that can be used for signal analysis (e.g., link training protocol analysis). It should be noted that while the sniffer device 102 is shown with a particular configuration and number of inputs/outputs, this is merely one example, and any suitable number of inputs and outputs can be used.

The output signal 108 is sent to a destination 114 from an output 118. The output signal 110 is sent to a destination 116 from an output 120. In one or more embodiments, the destinations 114, 116 are inputs to test equipment and signal destination of the communication link as described in more detail herein. That is, the input signal 106 is converted from an electrical signal to one or more optical signals towards test equipment, such that optical splitting is thereby provided. As such, the sniffer device 102 is configured to sniff or tap a high-speed electrical device without degrading the communication link between the source 104 and signal destination of the communication link.

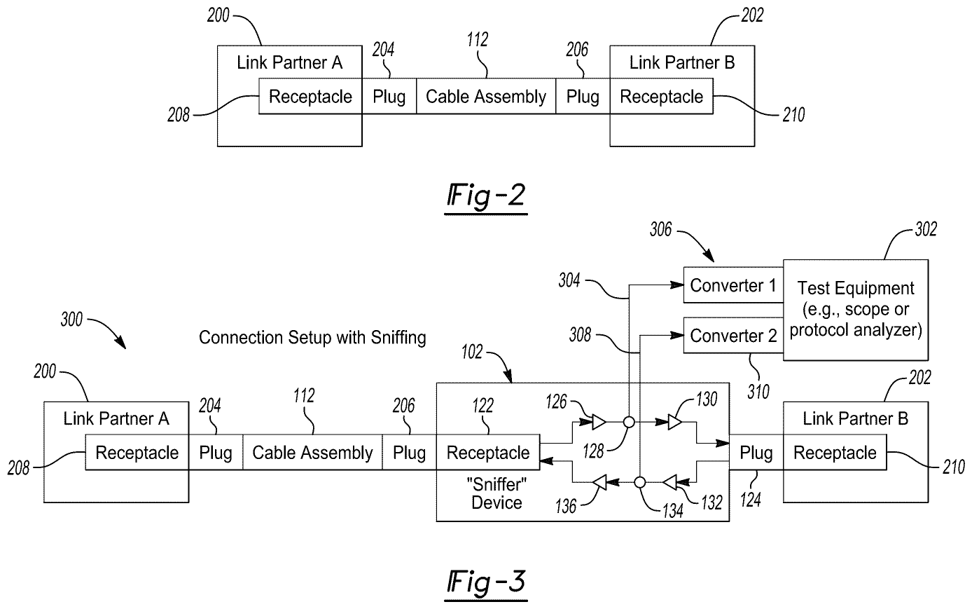

Various embodiments use optical components to solve issues (e.g., tapping or sniffing issues) in the electrical domain. For example, as described in more detail herein, the sniffer device 102 uses linear optics components or sub-systems or components to monitor the input signal 106, monitor link training, etc. with minimal signal impact (e.g., minimal degradation of the input signal 106), such as to a signal communicated across the cable assembly between a first link partner 200 (e.g., illustrated as link partner A, such as a device under test (DUT) port) and a second link partner 202 (illustrated as link partner B, such as a device under test (DUT) port) as shown in FIGS. 2 and 3.

More particularly, the cable assembly 112 having a signal of interest (e.g., signal to be monitored or tested) communicated there-across is connected to the first and second link partners 200, 202 using receptacle plugs 204, 206. For example, the receptacle plugs 204, 206 are configured for electrical connection of copper wires of the cable assembly 112 to two connection points or endpoints at the first and second link partners 200, 202. It should be appreciated that the first and second link partners 200, 202 can be any devices, connections, etc. that are electrically connected to the cable assembly 112. It should also be appreciated that the receptacle plugs 204, 206 can be any devices, connectors, adapters, etc. that allow for the electrical connection of the cable assembly 112 to the first and second link partners 200, 202 for signal transmission. In the illustrated example, the receptacle plugs 204, 206 are configured to electrically connect to corresponding receptacles 208, 210 of the first and second link partners 200, 202. That is, the receptacle plugs 204, 206 are complementary to the receptacles 208, 210 to allow for mating or coupling for signal transmission.

A connection arrangement 300 (e.g., a connection setup with sniffing) is shown in FIG. 3. In this illustrated example, the sniffer device 102 enables high-speed serial link (e.g., 400G or 800G Ethernet) troubleshooting by resolving high-speed signal sniffing. In one or more embodiments, the sniffer device 102 is configured to attach to the cable assembly 112 (e.g., copper cable assembly) such that the combined cable and device looks like a cable but has “sniffing” outputs using optical splitting. As can be seen, the sniffer device 102 includes a first connector, illustrated as a receptacle 122 and a second connector illustrated as a plug 124 configured to connect to the cable assembly 112, and together configured for bi-directional signal communication. For example, the sniffer device 102 includes the receptacle 122 on one end configured to connect to the cable assembly 112 (shown connected to the plug 206) and the plug 124 on another end configured to connect to one of the link partners (shown connected to the receptacle 210 of the link partner 202). As such, the sniffer device 102 is configured for electrical connection within the electrical signal path, which in this example, is between the cable assembly 112 and the second link partner 202, but uses optical splitting instead of electrical splitting for inspecting the electrical signals. The connection arrangement thereby enables, for example, high-speed serial link troubleshooting using high-speed signal sniffing with minimal signal degradation.

It should be noted that the plug 124 can use power supply contacts in the receptacle 210 for powering the active components of the sniffer device 102. More generally, power can be provided by other means, such as an internal battery.

It should be appreciated that the sniffer device 102 can be connected to different portions along the electrical signal path and the connection illustrated in FIG. 3 is merely an example. It should also be appreciated that the sniffer device 102 is not limited to a specific test function, but can be used in different testing and monitoring scenarios and settings, such as whenever electrical signals are to be inspected from the cable assembly 112.

The connectors and cables can also carry multiple signals (“lanes”) in each direction, and the sniffer device 102 may support more than one lane. As an example, Quad Small Form-Factor Pluggable (QSFP) connectors have four lanes in each direction, and Dual Small Form-Factor Pluggable (DSFP-DD) and Octal Small Form-Factor Pluggable (OSFP) connectors have eight lanes. The sniffer device 102 can be unidirectional, only sniffing one of the signals (or a set in one direction) in some embodiments (e.g., using two unidirectional sniffers instead of a bidirectional sniffer).

In one or more embodiments, the sniffer device 102 includes optical-to-electrical linear optics that convert high-speed electrical signals into optical signals, with a portion of the modulated optical signal then tapped out for use by test equipment 302 (e.g., oscilloscope or protocol analyzer). In one or more embodiments, the optical splitting can be done cleanly with negligible effect on the main signal (e.g., the input signal 106) using directional couplers or any type of optical couplers as described in more detail herein. The main optical signal is converted back to an electrical signal towards the link partner (e.g., the link partners 200, 202) to complete the link as described in more detail herein. This is done in both directions, and since the converters are linear, the sniffer device 102 is “transparent” and the effect on the signals is negligible.

With particular reference now to the sniffer device 102, optical-to-electrical linear optics are used for signal conversion. In one or more example, a first electrical to optical converter 126 is connected at an input side to the receptacle 122 and at the output side to a signal tap 128 that is configured to sniff the optical signal and provide the optical signal as an optical output 304 (e.g., fiber optical output) to the test equipment. That is, the first electrical to optical converter 126 converts the electrical signal from the cable assembly 112 (originating from the first link partner 200) to an optical signal. In this example, the optical output 304 is connected to a converter 306 at the test equipment that converts the optical output 304 to an electrical signal to input for testing. The output side of the first electrical to optical converter 126 is also connected to an input side of a first optical to electrical converter 130 configured to convert the optical signal that has been sniffed back to an electrical signal that is output to the second link partner 202 through the plug 124 and receptacle 210 connection arrangement in this example. This arrangement maintains the electrical path.

It should be appreciated that different configurations are contemplated. For example, another implementation of the sniffer device 102 includes the optical outputs 304, 308 and converters 306, 310 being inside the sniffer device 102, wherein the electrical cable assemblies extend from the converters 306, 310 to the test equipment 302.

The sniffer device 102 is configured for bi-directional signal communication and further includes a second electrical to optical converter 132 that converts the electrical signal from the second link partner 202 to an optical signal. In this example, the second electrical to optical converter 132 is connected at an input side to the plug 124 and at the output side to a signal tap 134 that is configured to sniff the optical signal and provide the optical signal as an optical output 308 (e.g., fiber optical output) to the test equipment. That is, the second electrical to optical converter 132 converts the electrical signal from the second link partner 202 to an optical signal. In this example, the optical output 308 is connected to a converter 310 at the test equipment that converts the optical output 308 to an electrical signal to input for testing or directly pass the optical output 308 (e.g., optical signal) to optical test equipment. The output side of the second electrical to optical converter 132 is also connected to an input side of a second optical to electrical converter 136 configured to convert the optical signal that has been sniffed back to an electrical signal that is output to the first link partner 202 through the receptacle 122, plug 206, the cable assembly 112 connection arrangement in this example. As such, bi-directional signal sniffing between the first link partner 200 and the second link partner 202 is thereby provided along the signal path.

In operation, the sniffer device 102 converts bi-directional high-speed electrical signals into optical signals with a portion of the modulated optical signals tapped or sniffed out for use by the test equipment 302. That is, the optical splitting is performed by a bi-directional coupler arrangement with negligible effect on the main signal as described in more detail herein. As such, signal conversion performed by the sniffer device 102 occurs in both directions, namely along the signal path from the first link partner 200 to the second link partner 202 and along the signal path from the second link partner 202 to the first link partner 200. As described in more detail herein, the sniffer device is “transparent” as the converters are linear, and hence the effect on the signals is negligible.

The sniffer device 102 effectively monitors high-speed signals in cable assemblies without disrupting or degrading the main signal transmission. The sniffer device 102 thereby provides solutions for the issues associated with signal integrity and performance degradation when tapping into electrical signals in copper cables. With the sniffer device 102, there is minimal insertion loss and/or complex setups are not needed that can interfere with the primary communication link. As such, the sniffer device 102 provides a reliable and efficient means to access and analyze signal data while maintaining the continuity of the original signal for troubleshooting and ensuring optimal performance in high-speed serial links.

The sniffer device 102 performs high-speed signal sniffing in cable assemblies using optical splitting that taps a portion of an optical signal converted from an electrical signal in a copper cable, with minimal impact on the main signal. The sniffer device 102 allows for full-duplex monitoring using signal converters and optical couplers (e.g., directional couplers) as described in more detail herein. The sniffer device 102 allows for analysis of electrical signals using tapped or sniffed optical signals for testing, facilitating high-speed serial link troubleshooting. In one or more embodiments, the sniffer device 102 is compatible with industry-standard test equipment and standard electrical connectors in copper cable segments. The sniffer device 102 in one or more embodiments ensures signal integrity while enabling full-duplex signal monitoring and testing of tapped or sniffed optical signals without affecting the main electrical signal between the link partners. That is, the sniffer device 102 performs sniffing in cable assemblies using optical splitters that tap a portion of an optical signal converted from an electrical signal carried by a copper cable with negligible effect on the main signal. The sniffer device 102 enables real-time monitoring of signal integrity without disrupting the primary communication channel, ensuring continuous system operation. Thus, by utilizing optical splitters, the sniffer device 102 provides a non-intrusive method for signal analysis, preserving the original electrical signal quality and bandwidth.

In one or more embodiments, the sniffer device 102 provides a modular design, allowing for easy integration into existing cable assemblies without significant modifications. For example, in one or more embodiments the sniffer device 102 includes attachable components (e.g., the receptacle 122 and the plug 124), facilitating quick setup and removal for troubleshooting purposes. It should be appreciated that in some embodiments, the sniffer device 102 is a standalone component (e.g., having a housing defining a standalone component), such as having a printed circuit board or substrate design with optical to electrical converter chips and electrical to optical converter chips and amplifier chips that boost or amplify signal strength (e.g., based on the amount of signal removed or tapped by the sniffer device 102). As a result, a signal to noise ratio is not negatively affected. In some embodiments, the sniffer device 102 is an integrated component, such as a photonic integrated circuit (e.g., integrated into a single photonic chip). The sniffer device 102 as described in more detail herein is an linear optics device, which is a device having linear drivers as described in more detail herein. That is, the sniffer device 102 uses linear optics components or sub-systems or components that can effectively monitor signals, monitor link training, etc. With the linear optics, the sniffer device 102 ensures reliable signal integrity during the conversion and monitoring processes.

The use of a directional coupler as the optical splitter as described in more detail herein also allows for precise control over the amount of signal tapped, enhancing the accuracy of signal monitoring. The directional coupler design minimizes back reflections and signal disturbances, which can improve the overall reliability of the signal sniffing process. And, incorporating an optical-to-electrical converter facilitates compatibility with existing electrical test equipment, allowing for seamless integration into current diagnostic setups (e.g., end-to-end electrical signal monitoring, providing comprehensive diagnostic capabilities). For example, the ability to reconvert the tapped optical signal into an electrical signal enables the use of conventional signal analysis techniques for full-duplex monitoring, reducing the need for specialized optical testing tools and facilitating real-time signal analysis and diagnostics on both the upstream and downstream channels, thereby improving network maintenance and troubleshooting processes.

In some examples, the sniffer device 102 uses optical splitters having minimal insertion loss (e.g., less than 1%). The low insertion loss characteristic contributes to energy efficiency, as it reduces the need for additional signal amplification, leading to cost savings in power consumption. However, as described in more detail herein, signal amplification or boosting can be provided as needed. The linear optical-to-electrical conversion process preserves the fidelity of the signal, ensuring that the integrity of the data is maintained during the conversion process, which allows for use in high-precision applications. And, maintaining signal integrity through linear conversion reduces the likelihood of errors and distortions, thereby enhancing the reliability and performance of the communication system in which the sniffer device 102 is deployed.

It should be noted that the sniffer device 102 can take different configurations and forms. For example, the sniffer device 102 in some examples further comprises a housing that is dimensioned to closely resemble a standard cable assembly. The design of the housing, which closely resembles a standard cable assembly, allows for seamless integration into existing infrastructure without the need for additional space or modifications, facilitating easy installation and reducing deployment costs. The sniffer device 102 allows for connection between two copper cable segments with standard electrical connectors. The ability to connect between two copper cable segments using standard electrical connectors enables the device to be universally compatible with existing copper network infrastructures, thereby reducing the need for specialized connectors. The use of standard electrical connectors also simplifies the installation process, as it allows for plug-and-play connectivity, thereby reducing setup time and potential connectivity issues that could arise from using proprietary or non-standard interfaces.

Moreover, the sniffer device 102 in one or more examples uses a tapped optical signal compatible with industry-standard test equipment ensuring that network technicians can use standard tools and procedures to monitor and analyze the tapped optical signal, which can streamline the testing process and reduce training requirements. Additionally, by adhering to industry standards, the device ensures interoperability with a wide range of test equipment, which can lead to cost savings by eliminating the need to invest in specialized or proprietary testing hardware.

The sniffer device 102 can be used, for example, with a method for high-speed serial link troubleshooting. In one or more embodiments, the method includes converting an electrical signal from a copper cable to an optical signal, tapping a portion of the optical signal for testing with an optical splitter, converting the tapped optical signal back to an electrical signal for analysis, and reconverting the main optical signal back to an electrical signal to continue the connection (e.g., maintain the signal path). This method enables non-intrusive monitoring of high-speed serial links by allowing signal quality testing without disrupting the communication flow, ensuring continuous system operation during diagnostics.

Thus, the sniffer device 102 is configured in various examples to facilitate signal testing or monitoring of electrical signals using linear optics. For example, electrical signals are tapped or sniffed using conversion (e.g., optical splitting) to optical signals with minimal effect upon the main signals. The sniffer device 102 allows for connection between any two DUT ports, such that that sniffer device 102 appears transparent or substantially transparent to the signal path. The tapped or sniffed signals can then be transmitted to test equipment capable of protocol analysis functions, debugging functions, etc.

The systems and methods described herein, including the components, processors, servers, controllers. etc. (e.g., sniffer device 102, the link partners 200, 202, the test equipment 302, etc.) can be implemented on a computing device 402. For example, the computing device 402 can be a personal computer, a desktop, a laptop, a tablet, a hand-held computer, a server, a workstation, a mainframe, a wearable computer, a supercomputer, or a combination thereof. However, it is understood that the aforementioned examples of what the computing device 402 may be is non-exhaustive and that the computing device 402 can be any related device. The computing device 402 generally includes a processor 404, a display adapter 406, one or more input/output port(s) 408, one or more input/output component(s) 410, a network adapter 412, a power supply 414, and a memory 416. However, it is understood that the computing device 402 can include any additional components therein and is not required to include any of the listed components (e.g., the processor 404, the display adapter 406, the one or more input/output port(s) 408, the one or more input/output component(s) 410, the network adapter 412, the power supply 414, and the memory 416).

The processor 404 is configured to provide instructions and/or processing power to the computing device 402 so that the computing device 402 can process one or more tasks including the implementation of a software program. It is also understood that the computing device 402 may include any number or processors 404 therein. The display adapter 406 can be a graphics card or a video board that provides the computing device 402 with a capability to display content on a display device 418. For example, the display device 418 can be any screen, monitor, and/or light-emitting component associated with any of the personal computer, the desktop, the laptop, the tablet, the hand-held computer, the server, the workstation, the mainframe, the wearable computer, the supercomputer, or a combination thereof. However, it is understood that the aforementioned examples of what the display device 418 may be is non-exhaustive and that the display device 418 can be any related device.

The input/output port(s) 408 provides a number of sockets for one or more cables to connect to the computing device 402. It is understood that there may be any number of input/output port(s) 408 on the computing device 402. For example, the input/output port(s) 408 provides a means for the computing device 402 to receive signals and/or data from an external device connected to the computing device 402 via the one or more cables. As another example, the input/output port(s) 408 provides a means for the computing device 402 to send signals and/or data from an external device connected to the computing device 402 via the one or more cables. The input/output component(s) 410 can include one or more components that support the input/output port(s) 408 such as, but not limited to, a switch, a push button, a pressure mat, a float switch, a keypad, a radio receive, or a combination thereof.

A network adapter 412 can be a network interface controller that is configured to provide a means for communicating over a network 420 using one or more communication links 422 as described in more detail herein. The power supply 414 is configured to convert alternating high voltage current (e.g., AC) into direct current (e.g., DC) to provide regulated power to the other components (e.g., the processor 404, the display adapter 406, the one or more input/output port(s) 408, the one or more input/output component(s) 410, the network adapter 412, and the memory 416) of the computing device 402.

Additionally, the memory 416 can be a mass storage device and/or a system memory such as a hard disk drive, a memory card, a solid-state drive, random access memory (RAM), or a combination thereof. The memory 416 is configured to provide a holding place for instructions and data associated with the operation of the computing device 402. The memory 416 can generally include an operating system 424. For example, the operating system 424 is configured to perform electrical signal protocol analysis 426 and/or process any of the data and/or instructions associated therewith using optical signals 428 acquired as described in more detail herein (e.g. tapped or sniffed by the sniffer device 102).

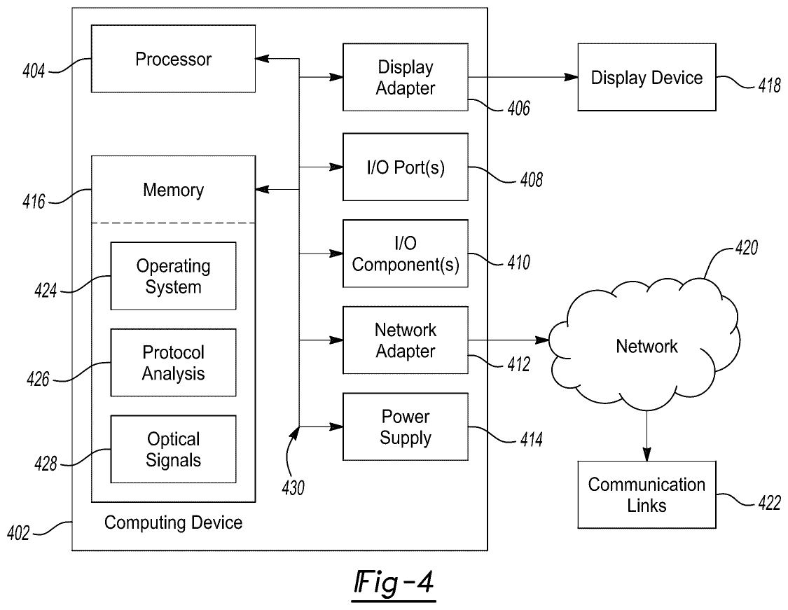

Furthermore, a system bus 430 is also included within the computing device 402 that is configured to couple each of the various components (e.g., the processor 404, the display adapter 406, the one or more input/output port(s) 408, the one or more input/output component(s) 410, the network adapter 412, the power supply 414, and the memory 416) of the computing device 402. While the operating environment illustrated within FIG. 4 depicts a particular configuration associated with at least the computing device 402 and the network 420, it is understood that the operating environment may be configured in any way.

As used herein, the phrase at least one of A, B, and C should be construed to mean a logical (A OR B OR C), using a non-exclusive logical OR, and should not be construed to mean “at least one of A, at least one of B, and at least one of C.”

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, computer-readable storage medium (tangible medium) are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs and/or cause one or more processors to perform one or more particular functions. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A sniffer device, comprising:
a first connector;
a second connector, wherein the first connector and the second connector are each configured to receive electrical signals;
a first electrical to optical converter and a first optical to electrical converter connected between the first connector and the second connector;
a second electrical to optical converter and a second optical to electrical converter connected between the first connector and the second connector;
a signal tap between the first electrical to optical converter and the first optical to electrical converter configured to tap optical signals converted from the electrical signals received at the first connector;
a signal tap between the second electrical to optical converter and the second optical to electrical converter configured to tap optical signals converted from the electrical signals received at the second connector; and
an optical output corresponding to the signal tap between the first electrical to optical converter and the first optical to electrical converter and an optical output corresponding to signal tap between the second electrical to optical converter and the second optical to electrical converter.

2. The sniffer device of claim 1, wherein the first connector comprises a receptacle configured to connect to a plug of a cable assembly to receive the electrical signals from the cable assembly.

3. The sniffer device of claim 1, wherein the second connector comprises a plug configured to connect to a receptacle of a link partner to receive the electrical signals from the link partner.

4. The sniffer device of claim 1, wherein the first connector and the second connecter are together configured to allow connection within an electrical signal path of a cable assembly to receive the electrical signals.

5. The sniffer device of claim 1, wherein the signal tap between the first electrical to optical converter and the first optical to electrical converter and the signal tap between the second electrical to optical converter and the second optical to electrical converter are configured to connect to optical to electrical converter of electrical test equipment or a tapped optical signal directly connected to optical test equipment.

6. The sniffer device of claim 1, wherein the first electrical to optical converter and the first optical to electrical converter connected between the first connector and the second connector, and the second electrical to optical converter and the second optical to electrical converter connected between the first connector and the second connector, together are configured for bi-directional signal communication.

7. The sniffer device of claim 1, wherein the first electrical to optical converter and the first optical to electrical converter connected between the first connector and the second connector, and the second electrical to optical converter and the second optical to electrical converter connected between the first connector and the second connector, each comprise at least one of a linear optics assembly or sub-system and one or more optical components.

8. The sniffer device of claim 1, wherein the electrical signals are transmitted over a cable assembly having copper wires.

9. The sniffer device of claim 1, further comprising a housing defining a standalone component.

10. The sniffer device of claim 1, further comprising a photonic integrated circuit implementing the sniffer device.

11. The sniffer device of claim 1, wherein the first optical to electrical converter and the second optical to electrical converter are configured to perform optical-to-electrical conversion that is linear.

12. The sniffer device of claim 1, wherein tapped optical signals are output to test equipment performing test functionality including protocol analysis.

13. A signal testing system, comprising:
a first connector and a second connector configured to receive electrical signals relating to a device under test;
a linear optics assembly or sub-system having one or more components connected to the first connecter and the second connector, the linear optics assembly or sub-system configured to convert the received electrical signals to optical signals;
one or more taps configured to tap the optical signals; and
test equipment configured to receive tapped optical signals from the one or more taps and perform test functionality on the tapped optical signals, wherein the test functionality includes protocol analysis.

14. The signal testing system of claim 13, wherein the linear optics assembly or sub-system comprises one or more electrical to optical converters.

15. The signal testing system of claim 13, wherein the linear optics assembly or sub-system comprises one or more optical to electrical converter.

16. The signal testing system of claim 13, wherein the linear optics assembly or sub-system comprises one or more optical to electrical converter chips and one or more electrical to optical converter chips that boost a signal strength of the received electrical signals.

17. The signal testing system of claim 13, wherein the linear optics assembly or sub-system or components are configured for bi-directional signal transmission.

18. The signal testing system of claim 13, further comprising a standalone sniffer device having the first connector and the second connector, the linear optics assembly or sub-system, and the one or more taps.

19. The signal testing system of claim 13, wherein the linear optics assembly or sub-system comprise a photonic integrated circuit.

20. A method for signal testing, the method comprising:
converting a main electrical signal from a copper cable to an optical signal using a linear optics assembly or sub-system having one or more components;
tapping a portion of the optical signal;
converting the tapped optical signal back to an electrical signal for analysis with electrical test equipment or directly connecting the tapped optical signal for analysis with optical test equipment; and
reconverting the main optical signal back to an electrical signal to complete an electrical path.
